(19) United States
(12) Patent Application Publication
(10) Pub. No.: US 2026/0241728 A1
(43) Pub. Date: Aug. 20, 2026

(54) PRINTING SYSTEM COMPRISING AN ADJUSTMENT ACTUATOR FOR THE ADJUSTMENT OF A PLURALITY OF PRINTER HEADS

(71) Applicant: Durst Group AG, Brixen (IT)

(72) Inventors: Clemens POERNBACHER, Sand In Taufers (IT); Manuel WIELAND, Vahrn (IT)

(21) Appl. No.: 19/156,764

(22) PCT Filed: May 13, 2024
(86) PCT No.: PCT/EP2024/025161

§ 371 Date: Aug. 14, 2025

(30) Foreign Application Priority Data
Jun. 5, 2023 (IT) 102023000011301

(51) Int. Cl. B41J 25/316; B41J 3/54; B41J 11/04; B41J 25/34; F16H 25/20

(52) U.S. Cl. CPC B41J 25/316; B41J 3/543; B41J 11/04; B41J 25/34; F16H 25/20; F16H 2025/2081; F16H 2025/2096

(57) ABSTRACT

Printing system with at least one print bar comprising at least a first and a second print head, wherein the printing system is designed such that the first and second print heads can be adjusted in relation to a printing medium by means of positioning and orientation using a single adjustment actuator, wherein an auxiliary device with the single adjustment actuator is arranged at the print bar in such a way that, with its aid, a working connection of the adjustment actuator with the first print head can be released and/or established and a working connection with the second print head can be released and/or established, characterized in that the adjustment actuator comprises:
only one motor,
a first screw head rotatably mounted around a first axis,
a second screw head rotatably mounted around a second axis,
a drive train which is drive-connected to the motor and the first and second screw heads in such a way that a rotary movement of the motor is turned into a simultaneous rotary movement of the first screw head around the first axis and of the second screw head around the second axis.

The present invention relates to a printing system with an adjustment actuator for adjusting multiple print heads.

Nowadays, a wide variety of printing systems with print heads can print on a wide variety of printing media, such as paper materials or corrugated cardboard, whereby the print heads in the printing system are either fixed or scannable relative to the printing medium. In any case, the printing system must be configured during initial startup, whereby correct adjustment of the print heads in relation to the printing medium through orientation and positioning is of great importance. If only individual defective print heads need to be replaced in an already adjusted system, it is usually only necessary to adjust the print heads newly inserted into the printing system. At this point, some terms used in this description should be defined before starting.

A printing system is a device that can be used to print a printing material onto a printing medium according to a specified pattern.

When this description refers to a print head, it means a component with one or more nozzles arranged in one or more rows through which the printing material can be dispensed in a precisely positioned and directed manner toward the printing medium. An arrangement of nozzles exactly belongs to one and the same print head if the printing system in the application is designed so that the arrangement can only be positioned and oriented as a whole. “In the application” means here that the print head is assembled and installed in the printing system.

An actuator is a general term for a component that converts electrical signals into mechanical motion or other physical quantities. Actuators within the meaning of the present invention convert electrical signals into mechanical motion.

When this description refers to an adjustment actuator, it means an actuator that can be used to mechanically move a first object (here, the print head) with which it is operatively connected in terms of positioning and orientation relative to a second object (here, for example, the print medium to be printed and/or an adjacent print head).

Positioning refers to the displacement of the first object to a target-position relative to the second object. Orientation refers to the rotation of the first object to a target-orientation relative to the second object.

When referring to a spur gear in this description, this means a cylindrical wheel or a cylindrical disc that is toothed on its circumference.

WO 2022 028 733 A2 discloses a printing system with a print bar comprising at least a first and a second print head, wherein an auxiliary device is provided in the printing system such that, with its aid, one after the other an operative connection of a first adjustment actuator with the first print head can be released and/or established and an operative connection of a second adjustment actuator with the second print head can be released and/or established, wherein each adjustment actuator comprises a motor.

The device disclosed in US2019255867A1 being of same genus is designed solely for adjusting several print heads on a single print bar, and comprises a plurality of motors mounted for joint movement, which are arranged in a row on a rail attached to the print bar and displaceable relative to the print bar, which row extends orthogonally to a transport direction of a print substrate, wherein the device is designed such that the plurality of motors enable simultaneous adjustment of a plurality of print heads at the print bar.

The previously known devices for adjusting print heads allow a relatively short setup time for adjusting print heads of a single print bar. However, they are relatively heavy and expensive to purchase and maintain.

The present invention is therefore based on the task of providing a printing system with a simple device for adjusting multiple print heads of a single print bar, which allows for a relatively short setup time, but is lighter in weight and at the same time inexpensive to manufacture.

According to the invention, the task is solved by a printing system comprising the features of claim 1. The subclaims relate to further advantageous and, where applicable, additionally inventive embodiments.

The printing system according to the present invention is a printing system with at least one print bar comprising at least a first and a second print head, wherein the printing system is designed such that the first and second print heads can be adjusted actuator based in relation to a printing medium by positioning and orientation by means of a single adjustment actuator, wherein an auxiliary device with the single adjustment actuator is arranged at the print bar in such a way that, with its aid, an operative connection of the adjustment actuator with the first print head can be released or established and/or an operative connection with the second print head can be released or established.

According to the invention, the adjustment actuator comprises:
only one motor,
a first screw head rotatably mounted about a first axis,
a second screw head rotatably mounted about a second axis,
a drive train that is connected to the motor and the first and second screw heads in such a way that a rotational movement of the motor is turned into a simultaneous rotational movement of the first screw head about the first axis and of the second screw head about the second axis.

By dispensing with multiple motors for adjusting the print heads of a single print bar, weight and, in particular, the cost of the auxiliary equipment can be reduced.

According to a preferred embodiment, the drive train comprises a wheel drive designed as a belt drive or as a belt and gear drive. This preferred further development offers the advantage that an adjustment device of a sophisticated and cost-effective design can be realized.

According to a further preferred embodiment, the wheel drive comprises:
a first spur gear, which is connected axially and rotationally fixed to the first screw head via a first output shaft rotatable about the first axis;
a second spur gear, which is connected axially and rotationally fixed to the second screw head via a second output shaft that can rotate about the second axis;
a motor spur gear, which is connected axially and rotationally fixed to a motor shaft of the motor;
wherein the motor spur gear is connected in a drive-connected manner to the first and second spur gears via a toothed belt.

This preferred further development offers the advantage that an adjustment device of a very simple and lightweight design can be realized.

Furthermore, according to a first preferred variant, it is possible for the motor spur gear to be directly drive-connected to the first and second spur gears via the toothed belt.

In addition, in an alternative preferred second variant, it is possible for the motor spur gear to be indirectly drive-connected to the first and second spur gears via the toothed belt, wherein the first spur gear is rotatably engaged with a first counter spur gear rotatable about an axis, which is axially connected to an additional first spur gear via a shaft, and the second spur gear is rotatably engaged with a second counter spur gear rotatable about an axis, which is axially connected to an additional second spur gear via a shaft, and wherein the motor spur gear is directly drive-connected to the additional first and second spur gears via the toothed belt.

Those axes of rotation around which the spur gears directly drive-connected via the toothed belt are rotatably mounted are preferably arranged relative to one another so that they form the corners of a fictitious triangle, in particular an isosceles triangle. This preferred further development offers the advantage that the reliability of the drive of the first and second screw heads can be increased.

According to a preferred embodiment, the first output shaft is displaceable along the first axis by means of a first hydraulically or pneumatically and/or electrically operated actuator between an extended position, in which the first drive shaft is operatively connectable to the first print head, and a retracted position, in which the first drive shaft is not operatively connected to the first print head, and that the second output shaft is displaceable by means of a second hydraulically or pneumatically and/or electrically operating actuator along the second axis between an extended position, in which the second output shaft is operatively connectable to the second print head, and a retracted position, in which the second output shaft is not operatively connected to the second print head. This allows a safe and simple mechanical connection between the motor of the adjustment actuator and the first and/or second print head to be established or released.

According to a further preferred embodiment, the motor is a stepper motor.

Furthermore, it is possible that the auxiliary device comprises at least one linear guide and a slide, wherein the slide is arranged so as to be displaceable on the linear guide and the adjustment actuator is attached to the slide, wherein the auxiliary device is mounted on and above the print bar.

According to a particularly preferred embodiment, the print bar comprises two rows of print heads aligned parallel to each other, wherein the first row of print heads comprises the first print head and the second row of print heads comprises the second print head, and wherein the first and second screw heads are arranged in such a way that, with the aid of the auxiliary device, an operative connection of the adjustment actuator via the first screw head with the respective print heads of the first row of print heads can be released or established one after the other and/or an operative connection via the second screw head with the respective print heads of the first row of print heads can be released or established one after the other.

Furthermore, it is possible that the printing system comprises a printing roller rotatable around an axis with a cylindrical roller shell, which is designed to receive the printing medium and rotate it in a direction of rotation, wherein the printing bar is assigned to the roller shell at a distance, and wherein the first axis of the first output shaft and the second axis of the second output shaft are aligned in a V-shape with respect to the printing roller, preferably with respect to the axis of rotation of the printing roller.

It is particularly preferred that the first spur gear and the counter spur gear rotatably engaged with the first spur gear are designed as a first bevel spur gear pair and the second spur gear and the counter spur gear rotatably engaged with the second spur gear are designed as a second bevel spur gear pair, wherein it is preferred that each bevel spur gear of a bevel spur gear pair is rotated relative to the other bevel spur gear of the bevel spur gear pair.

According to a further preferred embodiment of the printing system according to the invention, an optical means is provided in the printing system, which is designed in such a way that it enables automatic adjustment of the print heads, preferably via predetermined printed test patterns, wherein the optical means and the auxiliary device are designed to cooperate with each other. This further development is advantageous because, on the one hand, the maintenance effort for adjusting the print heads can be minimized and, on the other hand, the corresponding adjustment can even be carried out by a layman without specialist knowledge.

The printing system can be an inkjet printing system.

The invention will now be explained in detail with reference to the figures.

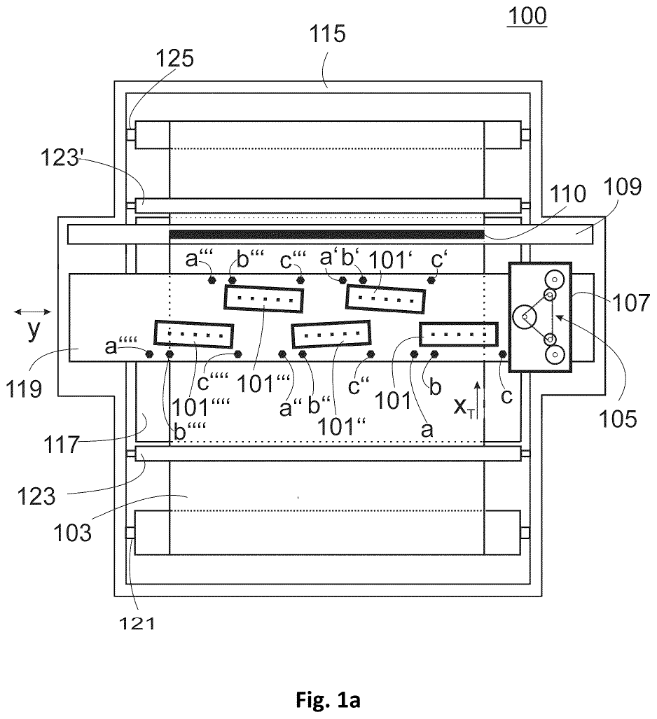

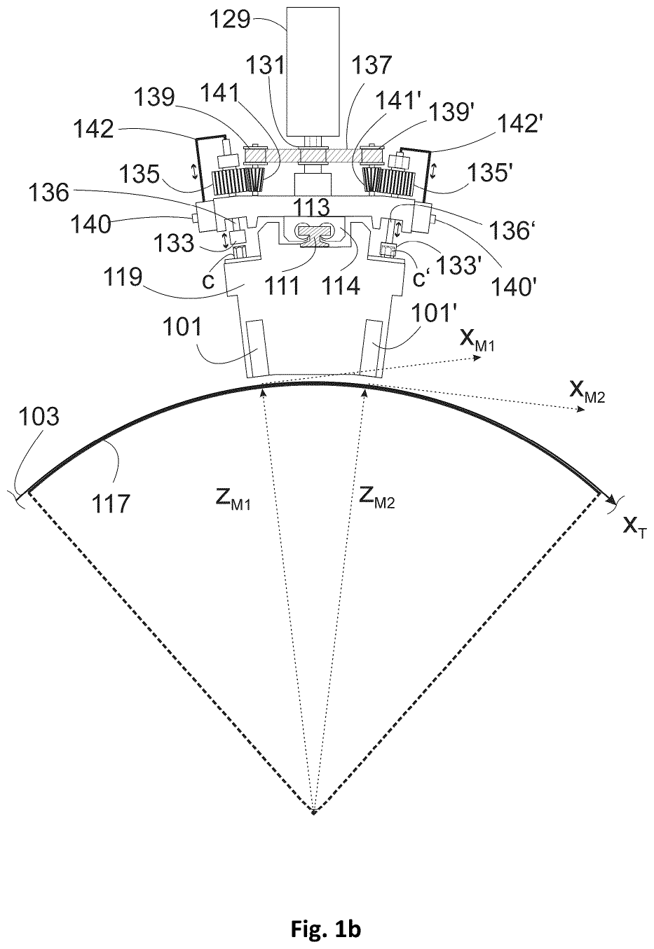

FIG. 1a shows a schematic top view of a particularly preferred embodiment of the printing system according to the invention with auxiliary device.

FIG. 1b shows a schematic front view of the second section of the printing system from FIG. 1a in cross-section.

The general principle of adjusting a print head in relation to a print medium, which in particular has a cylindrical shape, is known to the one skilled in the art and is explained, for example, in WO 2022 028 733 A2, cited in the introduction, on pages 5 to 8.

FIG. 1a shows a particularly preferred embodiment of the printing system 100 according to the invention, comprising three sections.

The first section comprises a device for unwinding a printing medium 103 with a first winding core 121, a dancer roller (not shown) and a deflection roller 123, via which the printing medium 103 can be guided to a printing roller with a cylindrical roller shell 117 as a receiving surface for receiving the printing medium 103. FIG. 1b shows a part of the printing roller as dashed lines connected to the cylindrical roller shell 117.

The second section comprises the printing roller with the cylindrical roller shell 117 for receiving the printing medium 103, to which roller shell 117 a color module for printing the printing medium 103 is assigned, wherein the color module comprises a print bar 119 with five printing heads 101, 101′, 101″, 101′″, 101″″, which is spaced apart from and opposite the roller shell 117. The printed printing medium 103 can be moved along a circular path over the cylindrical roller shell 117, during which the printing medium 103 can be printed with the nozzle rows (each shown as a dashed line in the respective print head) of the print heads 100, 101′, 101″, 101′″, 101″″. In the printing system 100, the color module is a single print bar 119.

The five print heads 101, 101′, 101″, 101′″, 101″″ are assigned an adjustment device by means of which the respective print heads 101, 101′, 101″, 101′″, 101″″ can be adjusted one after the other in relation to the printing medium 103 by positioning and orientation by means of a single adjustment actuator 105. An auxiliary device 107 is arranged at the print bar 119 in such a way that, with its aid, an operative connection between the adjustment actuator 105 and the first print head 101 can be released or established and/or an operative connection with the second print head 101′ can be released or established.

Accordingly, this preferred embodiment generally discloses a printing system 100 with at least one print bar 119, which comprises at least a first and a second print head 101, 101′, wherein the printing system 100 is designed such that the first and second print heads 101, 101′ can be adjusted in an actuator-based manner with respect to a printing medium 103 by positioning and orientation by means of a single adjustment actuator 105, wherein an auxiliary device 107 with the single adjustment actuator 105 is arranged at the print bar 119 in such a way that, with its aid, an operative connection of the adjustment actuator 105 with the first print head 101 can be released or established and/or an operative connection with the second print head 101′ can be released or established.

As a final and third section, the printing system 100 comprises a deflection roller 123′, via which the printing medium 103 can be conveyed to the device for winding the printing medium 103 onto a second winding core 125. The device for unwinding the printing medium 103 with the first winding core 121, the printing roller with cylindrical roller shell 117, the device for winding the printing medium 103 with the second winding core 125, the dancer roller and the two deflection rollers 123, 123′ are each rotatably mounted on a carrier 115 of the printing system 100. The ink module comprising the print bar 119 is mounted via a holder at adjustment means (not shown) which are designed to allow adjustment of the distance between the ink module and the cylindrical roller shell 117 or the printing medium 103, wherein the adjustment means are mounted on the carrier (not shown).

The first device for adjusting a print head, which is assigned to each of the five print heads 101, 101′, 101″, 101′″, 101″″, for each comprises an orientation device (not shown) and a first shaft a, a′, a″, a′″, a″″. The second device for adjusting a print head, which is assigned to each of the five print heads 101, 101′, 101″, 101′″, 101″″, for each comprises a displacement device (not shown) and a second shaft c, c′, c″, c′″, c″″.

The first shaft a′ is functionally connected to the orientation device via which the print head 101′ is arranged in the print bar 119, and the second shaft c′ is functionally connected to the displacement device via which the print head 101′ is arranged in the print bar 119. The other first shafts a, a″, a′″, a″″ and second shafts c, c″, c′″, c″″ are functionally connected to the other orientation and displacement devices of the corresponding print heads 101, 101″, 101′″, 101″″. The first shafts a, a′, a″, a′″, a″″ and the second shafts c, c″, c′″, c″″ are mechanical aids.

Each displacement device and the first shaft assigned to it are designed to work together that a rotation of the first shaft is converted into a displacement of a corresponding print head in the y-direction, and each orientation device and the second shaft assigned to it are designed to interact in such a way that a rotation of the second shaft is converted into a rotation of the corresponding print head about an axis of rotation that is essentially parallel to a momentary z_{M}-direction of the printing medium 103.

Accordingly, in a preferred embodiment, at least the first and second print heads 101, 105″ are each assigned a first mechanical aid for orientation and a second mechanical aid for positioning, such that the desired operative connection can be effected via the first and/or second mechanical aid, wherein the first and second mechanical aids are preferably an elongated shaft.

FIG. 1b shows that the print bar 119 from FIG. 1a carries a T-shaped linear guide 111, which extends over the print bar 119 in the y-direction. The auxiliary device 107 comprises a slide 113 and a handle 114, via which the slide 113 is coupled to the linear guide 111 and via which handle 114 the slide 113 is arranged so as to be displaceable along the T-shaped linear guide 111. The adjustment actuator 105 is attached to the slide 113, with the auxiliary device 107 mounted on and above the print bar 119. The print bar 119 comprises a displacement actuator (not shown) which is designed to move the slide 113 back and forth in the y-direction in a controlled manner along the linear guide 111.

As shown in detail in FIG. 1b, the adjustment actuator 105 comprises only a motor 129, a first screw head 133 rotatably mounted around a first axis, a second screw head 133′ rotatably mounted around a second axis, a drive train which is drive-connected to the motor 129 and the first and second screw heads 133, 133′ in such a way that a rotary movement of the motor 129 is turned into a simultaneous rotary movement of the first screw head 133 around the first axis and of the second screw head 133′ around the second axis.

The drive train comprises a wheel drive designed as belt drives and gear drive, wherein, as shown in FIG. 1b, the wheel drive comprises:
a first spur gear 135, which is connected axially and rotationally fixed to the first screw head 133 via a first output shaft 136 rotatable around the first axis;
a second spur gear 135′, which is connected axially and rotationally fixed to the second screw head 133′ via a second output shaft 136 rotatable around the second axis;
a motor spur gear 131, which is connected axially and rotationally fixed to a motor shaft of the motor 129;
wherein the motor spur gear 131 is drive-connected to the first and second spur gears 135, 135′ via a toothed belt 137.

Thereby motor spur gear 131 is indirectly drive-connected to the first and second spur gears 135, 135′ via the toothed belt 137, wherein the first spur gear 135 is in rotatable engagement with a first counter-spur gear 141 rotatable around an axis, which is axially connected to an additional first spur gear 139 via a shaft, and the second spur gear 135′ is in rotatable engagement with a second counter spur gear 141′ rotatable around an axis, which is axially connected via a shaft to an additional second spur gear 139′, and wherein the motor spur gear 131 is directly connected to the additional first and second spur gears 139, 139′.

As shown in FIG. 1a, those axes of rotation around which the spur gears 135, 135′ directly drive-connected via the toothed belt are rotatably mounted are arranged relative to one another such that they form the corners of a fictitious triangle.

The second output shaft 136′ is shown in FIG. 1b in an extended position in which it is operatively connected to the second print head 101′, and the first output shaft 136 is shown in a retracted position in which it is not operatively connected to the first print head 101.

In the printing system 100, according to the invention an auxiliary device 107 and an optical means 109 are foreseen such that, with their aid, automatic adjustment of the five print heads 101, 101′, 101″, 101′″, 101″″ is made possible by means of predetermined printed test patterns (not shown), in that print heads to be adjusted in several steps are adjusted in relation to the print medium 103 by orientation and positioning by means of an adjustment actuator 105, one after the other, by orientation and positioning. The printed test patterns can be optically detected with the camera 110 of the optical means 109 by the optical means 109. The optical means 109 and the auxiliary device 107 are designed to work together.

For this purpose, in a first step of the method, the print medium 103 is printed by ejecting ink in the form of drops via the five print heads 101, 101′, 101″, 101′″, 101″″ while the printing medium 103 is moved in a circular motion over the cylindrical roller shell 117 (see FIG. 1a and FIG. 1b) and the nozzle rows of the print heads 101, 101′, 101″, 101′″, 101″″ print a predetermined test pattern onto the printing medium 103 (not shown).

In a second step, the x_{M}-y-alignment and y-position of the nozzle rows of the respective print heads 101, 101′, 101″, 101′″, 101″″ is determined with the optical means 109, using the respective x-y-alignment of their test patterns printed on the print medium, and in a third step, an actual-target comparison is performed to identify print heads that need to be adjusted.

The target position of a predetermined test pattern is stored in an evaluation unit so that an actual-target comparison can be performed. In addition, the target alignment of a predetermined test pattern can be stored in the evaluation unit so that a corresponding actual-target comparison can also be performed. Alternatively, after step two has been completed, an actual alignment of one of the five printed test patterns can be selected as the target value either manually by a user or automatically by the evaluation unit on the basis of predetermined criteria and defined and used as the target alignment for the orientation of the remaining print heads.

If, for example, the x-y-alignment of a test pattern formed on the print medium 103 with a print head 101,101′, 101″, 101′″, 101″″ on the print medium 103 is not correct, the corresponding x_{M}-y-alignment of the relevant print head can be corrected by means of the adjustment actuator 105.

In the method and case according to this subject matter, the x_{M1}-y-alignment (see FIG. 1b) of the print head 101 was determined as the target alignment by the evaluation unit in an intermediate step after step two and before step three, and in step three, a deviation from their target orientation and target position was detected for the print heads 101′, 101″, 101′″, and 101′″. The x_{M1}-alignment of the print head 101 has an alignment angle of 90 degrees relative to the x_{M1}-direction associated with it.

In a fourth step, based on the situation shown in FIG. 1a and FIG. 1b, the deviation of the x_{M2}-y-alignment and the y-position of the print head 101′ to be adjusted from the TARGET-values is first minimized using the adjustment actuator 105. The x_{M2}-y-alignment of the print head 101′ is correct when its nozzle row has an x_{M2}-y-alignment of 90 degrees relative to the associated x_{M2}-direction, which corresponds to the actual alignment of the nozzle row of the print head 101.

For the corresponding adjustment, the auxiliary device 107 is provided in the printing system 100 in such a way that, with its aid, a working connection of the adjustment actuator 105 with and via the first shaft a′ to the printing head 101′ is established and, after adjustment, by orientation is released again and then an effective connection is established with and via the second shaft c′ with the print head 101′ and, after adjustment, by positioning is released again.

The effective connection between the adjustment actuator 105 and the shaft a′ is created by first moving the auxiliary device 107 to a specific position via the linear guide 111 and stopping it there. Then, the second output shaft 136′ is moved by the second pneumatically operated actuator 140′ along the second axis from its retracted position to an extended position in which the second output shaft 136′ is operatively connected to the second print head 101′, in which position the second screw head 133′ is functionally connected to the external hexagon of the shaft a′. The functional connection between the adjustment actuator 105 and the shaft a′—and thus between the adjustment actuator 105 and the print head 101′—is released again after adjustment by orienting the print head 101′, by moving the second output shaft 136′ by means of the second pneumatically operated actuator 140′ along the second axis from its extended position to the retracted position, in which the second output shaft 136 is not operatively connected to the print head 101. In this position, the second screw head 133′ is no longer functionally connected to the external hexagon of the shaft a′. An operative connection between the adjustment actuator 105 and a shaft a, a″, a″″, and/or a shaft c, c″, c″″ is created and then released in accordance with the procedure described in the previous sentence, but in contrast to this, with the first output shaft 136 by means of the first pneumatically operating actuator 140 via the first screw head 133 established and released again.

In a fifth step, with the aid of the auxiliary device 107, an operative connection is created between the adjustment actuator 105 and the print head 101″ with and via the shaft a″ and, after adjustment by orientation, it is released again and a working connection is created with and via the shaft c″ with the print head 101″ and released again after adjustment by positioning.

In a sixth step, with the aid of the auxiliary device 107, a functional connection is created between the adjustment actuator 105 and the print head 101″ with and via the shaft a′″ and, after adjustment by orientation, it is released again and a functional connection is created with and via the shaft c′″ to the print head 101′″ and, after adjustment by positioning, it is released again.

In a seventh step, with the aid of the auxiliary device 107, a functional connection is established between the adjustment actuator 105 and the print head 101″″ via the shaft a″″ and, after adjustment by orientation, released again and a functional connection is established with and via the shaft c″″ to the print head 101″″ and, after adjustment by positioning, released again.

After completion of the first adjustment process, at least one further test process is carried out in accordance with steps one and two described above and, if necessary, at least one further adjustment process is carried out until all print heads 101′, 101″, 101′″, 101″″ are correctly adjusted in relation to the printing medium 103 and an adjacent print head.

The print bar 119 from FIG. 1b comprises two rows of print heads (not shown) aligned parallel to each other which in the y-direction, wherein the first row of print heads comprises the first print head 101 and the second row of print heads comprises the second print head 101′, and wherein the first and second screw heads 133, 133′ are arranged in such a way that, with the aid of the auxiliary device 107, an operative connection of the adjustment actuator 105 via the first screw head 133 with the respective print heads of the first print head row can be released or established and/or an operative connection via the second screw head 133′ with the respective print heads of the first print head row can be released or established.

As shown in FIG. 1b, the printing system 100 comprises a print roller rotatable around an axis with a cylindrical roller shell 117, which is designed to receive the print medium 103 and to rotate it in a direction of rotation, wherein the print bar 119 is assigned to the roller shell 117 in a spaced apart manner, and wherein the first axis of the first output shaft 136 and the second axis of the second output shaft 136′ are aligned in a V-shape with respect to the printing roller, preferably with respect to the axis of rotation of the printing roller.

Thereby the first spur gear 133 and the second spur gear 133′ are each designed as bevel spur gears.

1. A printing system with at least one print bar comprising at least a first and a second print head, wherein the printing system is designed such that the first and second print heads can be adjusted in an actuator-based manner with respect to a printing medium by positioning and orientation by means of a single adjustment actuator, wherein an auxiliary device with the single adjustment actuator is arranged at the print bar in such a way that, with its aid, an operative connection of the adjustment actuator with the first print head can be released or established and/or an operative connection with the second print head can be released or established, the adjustment actuator comprises:
only one motor,
a first screw head rotatably mounted around a first axis,
a second screw head rotatably mounted around a second axis,
a drive train drive-connected to the motor and the first and second screw heads, such that rotational movement of the motor is turned into simultaneous rotational movement of the first screw head around the first axis and of the second screw head around the second axis.

2. The printing system according to claim 1, wherein the drive train comprises a wheel drive which is designed as a belt drive or as a belt and gear drive.

3. The printing system according to claim 2, wherein the wheel drive comprises:
a first spur gear which is connected axially and rotationally fixed to the first screw head via a first output shaft rotatable around the first axis;
a second spur gear which is connected axially and rotationally fixed to the second screw head via a second output shaft rotatable around the second axis;
a motor spur gear axially and rotationally fixed connected to a motor shaft of the motor;
wherein the motor spur gear is drive-connected to the first and second spur gears via a toothed belt.

4. The printing system according to claim 3, wherein the motor spur gear is directly drive-connected to the first and second spur gears via the toothed belt.

5. The printing system according to claim 3, wherein the motor spur gear is indirectly drive-connected to the first and second spur gears via the toothed belt, wherein the first spur gear is in rotatable engagement with a first counter spur gear rotatable around an axis, which is axially connected via a shaft to an additional first spur gear, and the second spur gear is in rotatable engagement with a second counter spur gear rotatable around an axis, which is axially connected via a shaft to an additional second spur gear, and wherein the motor spur gear is directly drive-connected to the additional first and second spur gears via the toothed belt.

6. The printing system according to claim 4, wherein axes of rotation about which the spur gears directly drive-connected via the toothed belt are rotatably mounted are arranged relative to one another such that they form the corners of a fictitious triangle, in particular an isosceles triangle.

7. The printing system according to claim 1, wherein the first output shaft can be displaced along the first axis by means of a first hydraulically or pneumatically and/or electrically operating actuator between an extended position, in which the first output shaft is operatively connectable to the first print head and a retracted position in which the first output shaft is not operatively connected to the first print head, and that the second output shaft can be displaced by means of a second hydraulically or pneumatically and/or electrically operated actuator along the second axis between an extended position, in which the second output shaft is operatively connectable to the second print head and a retracted position in which the second output shaft is not operatively connected to the second print head.

8. The printing system according to claim 1, wherein the motor is a stepper motor.

9. The printing system according to claim 1, wherein the auxiliary device comprises at least one linear guide and a slide, wherein the slide is arranged so as to be displaceable on the linear guide and the adjustment actuator is mounted on the slide, wherein the auxiliary device is mounted on and above the print bar.

10. The printing system according to claim 1, wherein the print bar comprises two rows of print heads aligned parallel to each other, wherein the first row of print heads comprises the first print head and the second print head row comprising the second print head, and wherein the first and second screw heads are arranged such that, with the aid of the auxiliary device, an operative connection of the adjustment actuator via the first screw head with the respective print heads of the first print head row can be released or established in succession and/or a functional connection via the second screw head with the respective print heads of the first print head row can be released or established in succession.

11. The printing system according to claim 10, wherein the printing system comprises a printing roller rotatable around an axis with a cylindrical roller shell which is designed to receive the printing medium and to rotate it in a direction of rotation, wherein the print bar is assigned to the roller shell at a distance, and wherein the first axis of the first output shaft and the second axis of the second output shaft are aligned in a V-shape with respect to the printing roller, preferably with respect to the axis of rotation of the printing roller.

12. The printing system according to claim 11, wherein the first spur gear and the counter spur gear rotatably engaged with the first spur gear are designed as a first bevel spur gear pair, and the second spur gear and the counter spur gear rotatably engaged with the second spur gear are designed as a second bevel spur gear pair, wherein preferably one bevel spur gear of a bevel spur gear pair is rotated relative to the other bevel spur gear of the bevel spur gear pair.
